(19) United States
(12) Patent Application Publication
(10) Pub. No.: US 2013/0324644 A1
(43) Pub. Date: Dec. 5, 2013

(54) BIO-DERIVED POLYESTER FOR USE IN COMPOSITE PANELS, COMPOSITE ARTICLES AND METHODS OF PRODUCING SUCH ARTICLES

(71) Applicant: BioAmber Inc., Plymouth, MN (US)

(72) Inventor: Louise Batchelor, Minneapolis, MN (US)

(21) Appl. No.: 13/907,207

(22) Filed: May 31, 2013

Related U.S. Application Data
(60) Provisional application No. 61/653,819, filed on May 31, 2012.

(51) Int. Cl. C08L 97/02

(52) U.S. Cl. CPC C08L 97/02
USPC 524/14; 264/331.17

(57) ABSTRACT

A synthetic article comprising at least one polyester resin adhesive and at least one lignin-based material and a method of preparing a synthetic article comprising mixing at least one polyester resin adhesive and at least one lignin-based material to obtain a blended material and forming a synthetic article from the blended material.

### RELATED APPLICATIONS

This application claims priority to U.S. Provisional Application No. 61/653,619, filed on May 31, 2012, the disclosure of which is incorporated by reference.

### TECHNICAL FIELD

This disclosure relates to materials comprising bio-derived polyesters. In particular, this disclosure relates to bio-derived polyesters used to make composite panels and products.

### BACKGROUND

Engineered wood, also called composite wood, synthetic wood, man-made wood, or manufactured board includes a range of derivative wood products manufactured by binding the strands, particles, fibers, or veneers of wood together with adhesives to form composite materials.

Adhesives commonly used for engineered wood are urea-formaldehyde resins (UF), phenol-formaldehyde resins (PF), and melamine-formaldehyde resin (MF). These adhesives may or may not be used in combination with methylene diphenyl diisocyanate (MDI) or polyurethane (PU) resins. Formaldehyde-based resins are subject to health and safety concerns and are not desirable for use in green or LEED related building products. Accordingly, there is a need for an adhesive that can be used to manufacture composite materials, engineered wood or synthetic articles that are not harmful to people who make and use them or to the environment.

### SUMMARY

I provide a composite material comprising at least one polyester-based resin adhesive and at least one lignin-based material and a method of preparing a synthetic article comprising a blend of at least one polyester resin adhesive and at least one lignin-based material.

### DETAILED DESCRIPTION

I provide composite materials and synthetic articles comprising polyester-based adhesives as a replacement for formaldehyde-based adhesives. The synthetic articles of this disclosure generally comprise a lignin-based material and a polyester-based resin adhesive or binding agent.

Preferably, a polyester-based resin adhesive comprises a bio-polyester. The term “bio-polyester” generally refers to a polyester polymer comprising at least one repeating unit comprising a component produced from a biomass-resource. For example, polyesters may typically be formed from repeating units comprising a diacid component and a diol component and one or both of the diacid and diol components may be obtained from fermentation of a carbon source by a microorganism. Methods of producing diacids from biomass-resources are known. For example, U.S. Pat. No. 8,203,021, which is incorporated herein by reference, discloses exemplary methods of producing dicarboxylic acids, such as succinic acid, from biomass-resources. Methods of producing diols from biomass resources are also known. For example, U.S. Pat. No. 8,410,291, which is incorporated herein by reference, discloses a suitable method of producing butanediol from biomass resources. It is also possible that at least some of one or both of the diacid and diol components are of petroleum-based origin. However, higher contents of components originating from biomass resources compared to petroleum are generally preferred and the polyester may consist or consist essentially of components produced from biomass resources.

The methods of producing the diol and dicarboxylic acid components and the polyester polymer are not particularly limited and may be accomplished by suitable known methods. Some examples include esterification of a dicarboxylic acid or transesterification of a dialkyl ester of dicarboxylic acid and polycondensation of the esterified dicarboxylic acid with a diol. For example, U.S. Pat. No. 6,495,656 and U.S. Pat. No. 7,985,566, which are incorporated herein by reference in their entirety, disclose methods of synthesizing polyesters and bio-polyesters.

As mentioned above, suitable polyester adhesives include polymers comprising repeating units comprising or formed from a dicarboxylic acid component and a diol component. A suitable diol component may be ethylene glycol, 1,3-propanediol (1,3 PDO) or 1,4-butanediol (1,4 BDO). It is preferred that at least one repeating unit of the polyester polymer comprises 1,3-propanediol as the diol component.

Examples of a dicarboxylic acid component include aliphatic dicarboxylic acids or mixtures thereof, aromatic dicarboxylic acids or mixtures thereof, and mixtures of aromatic dicarboxylic acid and aliphatic dicarboxylic acid. Examples of an aromatic dicarboxylic acid include terephthalic acid and isophthalic acid. Specific examples of the aliphatic dicarboxylic acid include linear or alicyclic dicarboxylic acids having typically 1 or greater but not greater than 36 carbon atoms, such as oxalic acid, succinic acid, glutaric acid, adipic acid, sebacic acid, dodecanedioic acid, dimer acid and cyclohexanedicarboxylic acid. It is preferred that at least one repeating unit comprises succinic acid or terephthalic acid as the dicarboxylic acid component.

Suitable polyesters also include copolymers comprising at least one additional repeating unit comprising a different dicarboxylic acid component and/or a different diol component. For example, a first repeating unit may comprise 1,3-propanediol as the diol component and succinic acid as the dicarboxylic acid component and a second repeating unit may comprise 1,3-propanediol as the diol component and terephthalic acid as the dicarboxylic acid component.

Suitable polyester polymers may comprise repeating units having the following formulas:

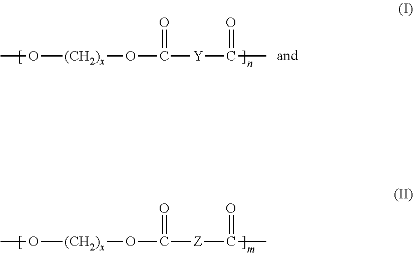

wherein n is an integer greater than 0;

wherein m is an integer greater than 0;

x=2, 3 or 4;

Y is a C₁ to C₃₆ linear aliphatic, a C₁ to C₃₆ alkoxy, a C₃ to C₃₆ branched aliphatic or cycloaliphatic, a C₆ to C₃₆ aryl, or a C₇ to C₃₆ alkylaryl;

Z is a C₁ to C₃₆ linear aliphatic, a C₁ to C₃₋₆ alkoxy, a C₃ to C₃₆ branched aliphatic or cycloaliphatic, a C₆ to C₃₆ aryl, or a C₇ to C₃₆ alkylaryl.

In preferred examples, Y or Z may be a C₂ linear aliphatic group or a phenylene aryl group. In some examples, such as in a homopolymer, Y may be equal to Z. Additionally, in preferred examples, x is 3. Preferably, if x=4, then at least one of Y or Z is not a C₂ linear aliphatic.

Particular examples of suitable polyester polymers may comprise at least one repeating unit having the following formula:

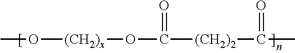

wherein n is an integer greater than 0 and x=3 or 4, but is preferably 3.

Particular examples of suitable polyester polymers may comprise at least one repeating unit having the following formula:

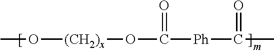

wherein m is an integer greater than 0, Ph is phenylene and x=3 or 4, but is preferably 3.

Examples of particularly suitable polyester resin adhesives include poly(1,3-propylene) succinate (“3GS”), poly(1,3-propylene) succinate-co-terephthalate (“3GS T”), and polybutylene succinate (“PBS”), poly(butylene succinate-co-terephthalte) (“PBST”), or combinations thereof. Synonyms for 3GS and 3GST include poly(trimethylene succinate) and poly(trimethylene succinate-co-terephthalate), respectively.

3GST polyester resins can be prepared, for example, by transesterification of a C₁-C₄ dialkyl ester of terephthalic acid with 1,3-propanediol, or esterification of terephthalic acid with 1,3-propanediol, followed by polycondensation, as is known. This process generally also involves transesterification of a dialkyl ester of succinic acid with 1,3 PDO or esterification of succinic acid with 1,3 PDO followed by polycondensation. 3GST may also be prepared, for example, from the co-polymer of 1,3 PDO, succinic acid and terephthalic acid. Equimolar quantities of succinic acid and terephthalic acid may be used in some examples.

While not wishing to be bound by theory, it is believed that the use of 3GS and/or 3GST is linked to a higher fiber or wood chip loading in the panel. This higher fiber or wood chip loading leads to a higher mechanical strength of the panel and use of the bio-derived polyester leads to an improved elasticity of the board as measured as the modulus of elongation.

Preferably, a polyester resin adhesive may be added as either a fiber or powder. While not wishing to be bound by theory, it is believed that the resinous material, when used in a state of a fiber or a powder, provides an advantage that a blended material can be formed by mechanical blending. In a case of utilizing the resin in a fiber state, the average fiber length is preferably equal to or larger than about 3 mm and equal to or smaller than about 102 mm. For example, when a polyester resin adhesive is used in fiber form, the average length of the fibers may be between about 15 mm and about 90 mm or about 25 mm and about 85 mm.

A suitable polyester adhesive composition may also comprise a blend of two or more polyester polymers or blend of at least one polyester polymer and at least one different polymer. For example, polyester resin adhesives may further comprise a polyethylene, such as Ultra-high-molecular-weight polyethylene (UHMWPE), Ultra-low-molecular-weight polyethylene (ULMWPE or PE-WAX), High-molecular-weight polyethylene (HMWPE), High-density polyethylene (HDPE), High-density cross-linked polyethylene (HDXLPE), Cross-linked polyethylene (PEX or XLPE), Medium-density polyethylene (MDPE), Linear low-density polyethylene (LLDPE), Low-density polyethylene (LDPE), Very-low-density polyethylene (VLDPE).

The amount of polyester polymer in the composite material is not particularly limited and may vary depending on, for example, the manufacturing methods or desired properties of the composite panel. In general, the composite material may comprise more than 0 wt % and less than about 50 wt % of polyester resin adhesive. Preferably, the composite material comprises less than about 25 wt %, less than about 15 wt %, less than about 10 wt %, less than about 7 wt %, less than about 5 wt %, or less than about 3 wt % of polyester polymer. Where the polyester-based resin adhesive comprises components other than polyester polymer, the composite material may comprise less than about 25 wt %, less than about 15 wt %, less than about 10 wt %, less than about 7 wt %, less than about 5 wt %, or less than about 3 wt % of total polyester-based resin. Examples of composite panels manufactured by compression molding may comprise polyester polymers in an amount between about 1 and 4 wt % of the synthetic article, more preferably between 1 and 2 wt % or between 3 and 4 wt % of the synthetic article.

Turning now to the lignin-based material, it is noted that the lignin-based material may comprise a natural fiber or powdered lignin or a combination thereof. A mixture of different natural fibers or a mixture of one or more natural fibers and a powdered lignin may further contribute to the mechanical and thermo-mechanical properties of the composite materials or synthetic article.

Any type of natural fiber may be used to make composite material, engineered wood or synthetic products and panels. Preferably, the natural fiber may be lignocellulose-based material and is not particularly restricted in type. Lignocellulose-based material may be derived from a plant, tree or herb and be principally constituted of lignin, cellulose and hemicellulose. A natural fiber may also be in the form of pulp, clippings, wood chips or wood shavings. Suitable examples of sources of natural fibers include, but are not limited to, miscanthus, hemp, switchgrass, grasses, canola, wheat and the like and combinations thereof. Preferably, one or more natural fibers may include at least one grass fiber selected from the group consisting of switchgrass, miscanthus, hemp, jute and kenaf, possibly in combination with another fiber.

Lignocellulose-based material may be turned into fibers by any method, for example, by a mechanical method utilizing a machine or an alkali treatment method of immersing the lignocellulose-based material in an aqueous alkali solution, or by various other methods such as steaming treatment or explosion treatment. U.S. Pat. No. 7,524,554, which is incorporated herein by reference, discloses a suitable example of producing natural fibers. The natural fibers do not require pre-treatment prior to being used in synthetic panels and products, but may be treated by known methods.

The source or type of powdered lignin is not particularly limited. In some examples, powdered lignin may be functionalized to improve compatibility with the polyester. Powdered lignin may comprise a lignin derivative separated from cellulose and other biomass constituents. Derivatives of lignin can be obtained by any suitable method, including but not limited to, (1) solvent extraction of finely ground wood (milled-wood lignin, M L), (2) acidic dioxane extraction (acidolysis) of wood, (3) steam explosion, (4) dilute acid hydrolysis, (5) ammonia fiber expansion, (6) autohydrolysis methods. Exemplary lignin-based materials and lignin derivatives and the method of producing lignin derivatives are disclosed in WO/2011/097719 and U.S. Pat. No. 4,764,596, both of which are incorporated herein by reference in their entirety.

Water may be added to the lignin-based material to alter the moisture content, but the moisture content is not particularly limited. Suitable moisture content may vary depending on the source or particle or fiber size of the lignin-based material or mixture thereof. The lignin-based material may have a moisture content of less than about 10%, such as 2% to 8%.

The amount of lignin-based material in the synthetic article is not particularly limited and may vary depending on, for example, the manufacturing methods or desired properties of the synthetic article. In general, the composite material may comprise less than 100 wt % and more than about 65 wt % of lignin-based material. More preferable, a composite material may comprise more than about 75 wt %, more than about 80 wt %, more than about 85 wt %, more than about 90 wt %, more than about 93 wt %, more than about 95 wt %, or more than about 97 wt % of lignin-based material. Preferred examples of composite panels manufactured by compression molding may comprise lignin-based material in an amount greater than about 96% and less than 100%, more preferably between 98 and 99 wt % or between 96 and 97 wt % of the composite panel.

Additives used in engineered wood panels may also be included in a polyester adhesive as desired. Suitable additives include, but are not limited to, expoxidized oils, MDI, epoxidized soy bean oil, polymeric diphenyl methane isocyanate (PMDI), KRASOI®NN22, LUPEROX®, antioxidants, matting agents, foaming agents, lubricants, releasing agents, antistatic agents, ultraviolet absorbers, photostabilizers, cross-linking agents, heat, stabilizers, deodorants, flame retarders, sliding agents, perfumes, antibacterial agents, waterproofing agents, flame retardants and other known or suitable additives. In addition, a pigment(s) and/or a dye(s) may be added to obtain a finish of a desired color. Also, any of various coupling agents, processing agents may be included.

The polyester resin adhesive and lignin-based material can be used to prepare a blended material for use in making a number of synthetic articles. Exemplary synthetic articles include those that may be used in the place of natural wood, including but not limited to boards, panels, posts, studs, building materials and the like. Methods of making synthetic articles are not particularly restricted, but may include preparation of cushion-like blend material and press molding under heating, injection molding or injection compression molding. Suitable pressure and temperature ranges for the molding process can be selected by one of ordinary skill in the art. Preferably, the temperature of the molding process may be at least as high as the glass transition point(s) or melting point(s) of the polyester(s) in the blended material. Exemplary methods of making composite panels comprising lignin-based material and a polyester are disclosed in US 2012/0071591, which is incorporated herein by reference in its entirety.

Preferably, the blended material comprising a polyester resin adhesive, lignin-based material and, optionally, one more additive is placed in a mold of a shape corresponding to the synthetic article, such as a board, to be prepared. The blended material is then subjected to press molding under heating, whereby the bio-polyester resin material in the blended material is fused to firmly adhere the lignocellulose-based material thereby providing a synthetic board in the shape of the mold.

Alternatively, the blended material comprising a polyester resin adhesive, lignin-based material and, optionally, one more additive is charged in an injection compression molding machine having an orifice of a shape corresponding to the synthetic article to be formed and the blended material is pressurized, heated, and is extruded from the orifice to prepare a synthetic board. In this operation, as the blended material contains micro hollow material, the specific gravity of the synthetic article is appropriately reduced to achieve a weight reduction in the synthetic board.

The heated press molding method has an advantage that the synthetic board can be prepared inexpensively with a simple facility. In injection compression molding, the lignocellulose-based material, the resinous material and the micro hollow material are kneaded in advance by an extruder. However, this method can produce the synthetic board in continuous manner by forming the blended material into pellets and charging the pellets into the injection compression molding machine and provides an advantage that the synthetic board can be produced in a large amount.

Synthetic articles may be manufactured as composite panels comprising one or more layers. For example, composite panels may have a three-layer symmetric structure, with a middle core layer and a lower surface layer and an upper surface layer. The two surface layers (upper and lower) may be prepared using a different formulation of materials than the core layer. For example, the surface layer may comprise a lignin-based material of fine particles, whereas the core layer may comprise a lignin-based material of wood shavings or flakes. Methods of preparing layered composite panels are known in the art.

An exemplary synthetic article may have a flexural modulus of rupture (MOR) greater than or equal to about 11.0 MPa, or preferably greater than or equal to about 14.5 MPa, or even more preferably greater than or equal to about 16.5 MPa. An exemplary synthetic article may have an MOR greater than or equal to about 21.6 MPa, or preferably greater than or equal to about 27.9 MPa.

An exemplary synthetic article may have a flexural modulus of elongation (MOE) greater than or equal to about 1725 MPa, or preferably greater than or equal to about 2250 MPa, or preferably greater than or equal to about 2750 MPa, or even more preferably greater than or equal to about 2400 MPa.

An exemplary synthetic article may have an internal bond (IB) greater than or equal to about 0.40 MPa, or preferably greater than or equal to about 0.45 MPa, or preferably greater than or equal to about 0.55 MPa, or preferably greater than or equal to about 0.81 MPa or even more preferably greater than or equal to about 0.90 MPa.

An exemplary synthetic article may have a density between about 500 and 1000 kg/m³, such as about 640 to 800 kg/m³.

Where synthetic articles are formed as composite panels, exemplary composite panels may meet or exceed the minimum physical and mechanical standards for panel boards, such as particle board and medium-density fibreboard (MDF), such as standards set forth in American National Standard Particle Board, ANSI A208.1-1999, Composite Panel Association (approved) Feb. 8, 1999 as measured according ASTM D 1037. For example, the composite panels may have one or more physical properties of Modulus of Rupture (MOR), Modulus of Elongation (MOE), Internal bond strength (IB), or Density meeting or exceeding one of M-3, M-2, M-1 or H-1 Grades for particle board or one of Grade 155, Grade 130, Grade 115 for MDF. Table 1 provide the Grade standards for particle board and Table 2 provides the Grade standards for MDF.

TABLE 1
Particle Board Standards

| | MOR | MOE | IB | Density |
|---|---|---|---|---|
| Grade | (MPa) | (MPa) | (MPa) | (kg/m³) |
| H-1 | >16.5 | >2400 | >0.90 | >800 |
| M-3 | >16.5 | >2750 | >0.55 | 640-800 |
| M-2 | >14.5 | >2250 | >0.45 | 640-800 |
| M-1 | >11.0 | >1725 | >0.40 | 640-800 |

TABLE 2
MDF Standards

| | MOR | MOE | IB | Density |
|---|---|---|---|---|
| Grade | (MPa) | (MPa) | (MPa) | (kg/m³) |
| 115 | >12.4 | >1241 | >0.47 | Typical |
| 130 | >21.6 | >2160 | >0.54 | value = |
| 155 | >27.9 | >2792 | >0.81 | 500-1000 |

Synthetic articles of this disclosure may comprise a polyester resin as an adhesive or binding agent and be free or essentially free of a resin comprising or made from a formaldehyde component, such as urea-formaldehyde resins (UF), phenol-formaldehyde resins (PF), and melamine-formaldehyde resin (MF). Synthetic articles essentially free of a resin comprising a formaldehyde component may be manufactured without the addition of a resin comprising a formaldehyde component and may contain no formaldehyde other than amounts naturally occurring in the raw materials or trace amounts.

The synthetic articles of this disclosure may be further understood from the following non-limiting examples.

### EXAMPLES

Exemplary panels were produced to measure the mechanical and physical properties of MOR, MOE, IB and Density of the composite panels using ASTM D 1037. The modulus of rupture and modulus of elongation were measured in three specimens for each example. Internal bond strength was measured in three to six specimen for each example. A standard deviation for the measurements is presented in parentheses.

### Example 1

Two exemplary panels were formed to have a three-layer symmetric structure, with a middle core layer and a lower surface layer and an upper surface layer. The two surface layers (upper and lower) were prepared using of fine particles whereas the core layer was prepared using shavings or flakes.

Table 3 provides the type of each raw material used to make the composite panels and Table 4 provides the quantity in terms of wt % of the composite panel. The quantity of each raw material for one panel was determined in accordance with the formulation, the target dimensions and density of the panel:

Dimensions: 500×500×15 mm (20×20×⅝ inch)

Density: about 780 kg/m3 (48.7 pcf)

TABLE 3
Materials used for the manufacturing of composite panels

| | Product name | | |
|---|---|---|---|
| Material | Formulation | Supplier | Note |
| Wood | | Uniboard | Moisture content |
| | | Canada | 1.8%, as received |
| polymeric | | Bayer | |
| diphenyl | | | |
| methane | | | |
| diisocyanate | | | |
| (pMDI) resin | | | |
| Poly(tri- | 3GST (50:50 Mol | BioAmber: | Melting point |
| methylene | wt % Succinic | Produced | 140.3° C. |
| succinate-co- | acid and | by DuPont | Molecular Weight: |
| terephthalate) | terephthalic | | according to the |
| | acid) | | Goodyear Intrinisic |
| | | | viscosity test (IV): |
| | | | dL/g = 0.89 |
| Linear low | MC 705145-PE | Nexeo | Melting point |
| density | LLD GI2024A NAT | Solutions | 124.7° C. |
| polyethylene | PWD NOVAPOL | | |
| (LLDPE) | | | |

TABLE 4
Formulations for composite panel manufacturing

| Example | Wood (95 or 90 wt % total) | | Binder (5 wt % total) | | |
|---|---|---|---|---|---|
| Panel No. | Surface | Core | pMDI | 3GST | LLDPE |
| 1 | 38.0% | 57.0% | 1% | 1% | 3% |
| 2 | 38.0% | 57.0% | 1% | 2% | 2% |

The moisture content of the raw material wood particles was measured at 1.8% and the actual moisture content was adjusted to 4% for the core particles and 6% for the surface particles, respectively, by spraying of water. The wood particles were then combined with binder resin compositions identified in Table 4 and resin blending was performed in a rotary drum blender. Firstly, wood particles (either core or surface) and all the components of the binder and additives, except the pMDI resin, were poured into the blender. After having been blended for 5 minutes, the pMDI resin was sprayed and the blending continued for another 5 minutes.

The blended particles were put into a wooden frame in the order of surface-core-surface and formed manually a three-layer mat confined between two aluminum cauls. The formed mat was then loaded into a hydraulic hot press with plate temperature of 182° C. The total press cycle was 10 minutes divided into three steps: 1) 30 seconds for press closing and reaching the target thickness; 2) 8 minutes for holding at the target thickness and 3) 90 seconds for degas. The holding time was determine based on the following two observations: 1) the minimum time for the core temperature to reach 150° C. varied between 2-6 minutes and 2) it took about 8 minutes for the pMDI resin to achieve its maximal possible degree of curing at a temperature range between 100 to 180° C. and with a heating rate of 10° C./min (measured by thermo-mechanical analysis).

Table 5 provides the measured physical properties of Example Panel Nos. 1 and 2 in US Standard Units and Metric Units. Each of Example Panel Nos. 1 and 2 resulted in satisfactory modulus of rupture, modulus of elongation, and internal bond strength.

TABLE 5
Performance testing results

| Example | | | | |
|---|---|---|---|---|
| Panel No. | MOR | MOE | IB | Density |
| US Standard | KPSI | KPSI | PSI | pcf |
| Units | | | | |
| 1 | 2.23 (0.14) | 497 (17) | 72.9 (12.1) | 49.4 (0.9) |
| 2 | 1.98 (0.16) | 454 (33) | 87.1 (9.3) | 49.1 (1.0) |
| Metric Units | MPa | MPa | MPa | kg/m³ |
| 1 | 15.36 (0.99) | 3428 (119) | 0.503 (0.083) | 791 (15) |
| 2 | 13.62 (1.08) | 3129 (229) | 0.600 (0.064) | 787 (16) |

### Example 2

The experimental procedure used to produce Example Panel No. 3 is same as used in Example 1. The difference is that a hybridized fiber mix is used as a lignin-based material. The lignin-based material comprised a hybridized mixture of wood chip, wheat and canola. The fibers were precut and blended with the 3GST, LLDPE and an additive mix (including a cross-linking agent and water treatment additive) in the quantities provided in Table 6.

TABLE 6
Formulations for composite panel manufacturing

| | | |
|---|---|---|
| Example | Wood, Wheat and | Binder (5.5%) |

| Panel No. | Canola Blend | Additives | 3GST | LLDPE |
|---|---|---|---|---|
| 3 | 94.5% | 1.5% | 1 | 3 |

Table 7 provides the measured physical properties of Example Panel No. 3 in US Standard Units and Metric Units.

TABLE 7
Performance testing results

| Example | | | | |
|---|---|---|---|---|
| Panel No. | MOR | MOE | IB | Density |
| US Standard | KPSI | KPSI | PSI | pcf |
| Units | | | | |
| 3 | 4.02 | 425 | 237.1 | 47 |
| Metric Units | MPa | MPa | MPa | kg/m³ |
| 3 | 27.7 | 2930 | 1.64 | 753 |

Example Panel 3 resulted in particularly excellent MOR, MOE and IB values which exceed the standard for M-3 and H-1 and a MOR value that exceeded the MDF standards for Grade 155.

All patents, published patent applications, publications, industry standards and the subject matter mentioned therein are incorporated herein by reference.

Although my processes have been described in connection with specific steps and forms thereof, it will be appreciated that a wide variety of equivalents may be substituted for the specified elements and steps described herein without departing from the spirit and scope of this disclosure as described in the appended claims.

1. A composite material comprising at least one polyester resin adhesive and at least one lignin-based material, wherein the polyester resin adhesive comprises a polyester polymer having at least one repeating unit formed from a diol component and a dicarboxylic acid component and wherein the diol component is 1,3 propanediol.

2. The composite material of claim 1, wherein the dicarboxylic acid component is succinic acid.

3. The composite material of claim 1, wherein the dicarboxylic acid component is terephthalic acid.

4. The composite material of claim 1, wherein at least one repeating unit of the polyester polymer is formed from a diol component selected from the group consisting of ethylene glycol and 1,4-butanediol.

5. The composite material of claim 1, wherein the polyester polymer is a copolymer comprising at least one repeating unit comprising succinic acid as the dicarboxylic acid component and at least one repeating unit comprising terephthalic acid as the dicarboxylic acid component.

6. The composite material of claim 1, wherein at least one repeating unit of the polyester polymer comprises a component produced from a biomass-resource.

7. The composite material of claim 1, wherein the polyester polymer consists essentially of components produced from a biomass-resource.

8. The composite material of claim 1, wherein the lignin-based material comprises at least one selected from the group consisting of a natural fiber, a powdered lignin, and a combination of natural fiber and powdered lignin.

9. The composite material of claim 1, wherein the polyester resin adhesive comprises less than about 25 wt % of the composite material.

10. The composite material of claim 1, wherein the lignin-based material comprises more than about 75 wt % of the composite material.

11. The composite material of claim 1, wherein the polyester resin adhesive is in fiber or powder form.

12. The composite material of claim 1, wherein the polyester resin adhesive comprises at least one additive.

13. The composite material of claim 1, wherein the polyester resin adhesive comprises a blend of the polyester polymer and at least one different polymer.

14. The composite material of claim 1, wherein the polyester resin adhesive comprises a blend of the polyester polymer and at least one polymer selected from the group consisting of polybutylene succinate and polybutylene succinate terephthalate.

15. A synthetic article comprising at least one polyester resin adhesive and at least one lignin-based material, wherein the polyester resin adhesive comprises a polyester polymer having repeating units according to the following formulas: 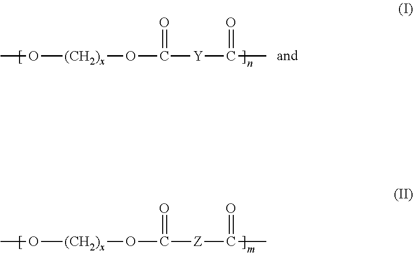
wherein n is an integer greater than 0;
wherein m is an integer greater than 0;
Y is a C₁ to C₃₆ linear aliphatic group, a C₁ to C₃₋₆ alkoxy group, a C₃ to C₃₆ branched aliphatic or cycloaliphatic group, a C₆ to C₃₆ aryl group or a C₇ to C₃₆ alkylaryl group;
Z is a C₁ to C₃₆ linear aliphatic group, a C₁ to C₃₋₆ alkoxy group, a C₃ to C₃₆ branched aliphatic or cycloaliphatic group, a C₆ to C₃₆ aryl group or a C₇ to C₃₆ alkylaryl group;
x=2, 3 or 4, but if x=4, then at least one of Y or Z is not a C₂ linear aliphatic.

16. The synthetic article of claim 15, wherein the polyester resin adhesive comprises a polyester polymer having at least one repeating unit having the following formula: 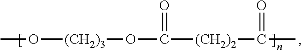
wherein n is an integer greater than 1.

17. The synthetic article of claim 15, wherein the polyester polymer comprises at least one repeating unit having the following formula: 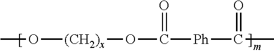
wherein m is an integer greater than 1, Ph is phenylene and x=2, 3 or 4.

18. The synthetic article of claim 15, wherein Y is a C₂ linear aliphatic.

19. The synthetic article of claim 15, wherein x=3.

20. The synthetic article of claim 15, wherein Z is phenylene.

21. A composite panel formed from the composite material of claim 1, where at least one of a modulus of rupture, modulus of elongation, internal bond strength, or density satisfies at least one of the following grading standards: M-3 for particle board, M-2 for particle board, M-1 for particle board, H-1 for particle board, Grade 155 for MDF, Grade 130 for MDF, or Grade 115 for MDF.

22. A method of preparing a synthetic article from the composite material of claim 1, comprising placing the composite material in a mold, applying heat and pressure to the blended material in the mold to bind the composite material, and removing the synthetic article from the mold.
